(19) United States
(12) Patent Application Publication
(10) Pub. No.: US 2022/0329652 A1
(43) Pub. Date: Oct. 13, 2022

(54) METHOD OF DISTRIBUTING SERVICE SERVER DYNAMICALLY

(71) Applicant: CHARLES LAP SAN CHAN, Hong Kong Island (HK)

(72) Inventor: CHARLES LAP SAN CHAN, Hong Kong Island (HK)

(21) Appl. No.: 17/713,065

(22) Filed: Apr. 4, 2022

(30) Foreign Application Priority Data
Apr. 8, 2021 (TW) 110112625

(51) Int. Cl. H04L 67/1025; H04L 67/141

(52) U.S. Cl. CPC H04L 67/1025; H04L 67/141

(57) ABSTRACT

The present invention discloses a method of distributing service server dynamically. Specifically, the present invention relates to a service server distribution method which allows the modification of system distribution rule. The present invention allows distributing service server data from different group of service servers to different client devices. The system distribution rule which is in the index server at the system end and used for distributing different group of service server data to different client devices may be freely modified. On the other hand, the client devices at the client end may modify the corresponding client distribution rule. The client distribution rule is used to determine establishing the connection between the client device and specific service server. Therefore, the present method of distributing service server dynamically may reduce the load of index server and distribute the service servers which are set up by/for different organization or service type.

### TECHNICAL FIELD

The present invention discloses a method of distributing service server dynamically. Specifically, the present invention indicates a service server distribution method which allows the modification of system distribution rule.

### BACKGROUND OF RELATED ARTS

Nowadays, when user request a specific web services or applications on the internet, it is commonly access a specific URL and thought the index server links to this URL to provide the actual service server which user needs. For instance, when the user(s) need(s) to hold an online meeting (or conference call) based on communication software, the invitations for the invited team members may be established after the meeting which has been held based on using computer or smart phone to log in to the website of the communication software. The user and his/her team members are distributed to each service server providing the services which is at the post end by the already set rule of index server of the communication software.

The abovementioned description indicates that the index server of the communication software needs to bear higher computational effort, and the increased number of the users may cause obstacles of computing performance. For example, if the user establishes a hundred-person meeting, and the index server is needed to bear the distribution task of the one hundred users the belonging service server per se. Obviously, if hundred meetings for multiple users are held simultaneously, the load of the index server may significantly increase.

Furthermore, the obstacles of the index server computing performance has been considered, however, the other problem is that the user cannot use or log in the certain communication software without understanding the correct URL, even changing another network service provider cannot, either. In other words, the increasing number of the network service provider may create numerous kinds of URL and login requirements.

The former description states that the user may feel inconvenient and confused when he/her uses the services provided by different providers. Therefore, the way to rapidly solve the abovementioned problems becomes important research for skilled person in this industry.

### SUMMARY

The main purpose of the present invention is to provide a method of distributing service server dynamically which is used for sharing the load of index server.

Another purpose of the present invention is to provide a method of distributing service server dynamically, and therefore to distribute service servers which belong to different organizations or service types.

The other purpose of the present invention is to provide a method of distributing service server dynamically. This method may distribute service servers based on a system distribution rule defined by the system provider or the distribution rule which is defined by user per se.

The abovementioned purpose may be realized by a method of distributing service server dynamically of the present invention. This invention is operated under the network between an index server, a plurality of client devices and a plurality of service servers. In other words, the index server, the plurality of client devices and the plurality of service servers are connected to each other based on an internet. The following steps indicate the mechanism of the index server, the plurality of client devices and the plurality of service servers therebetween:

(A) sending a plurality of service server data which are corresponding to the plurality of service servers to the index server;

(B) saving a plurality of client device data of the plurality of client devices in the index server;

(C) at least one client device of the plurality of client devices sending a connection service request to the index server;

(D) sending at least one service server data of the plurality of service server data to the at least one client device for responding the connection service request; and

(E) establishing a connection between the at least one client device and a server which is corresponding to the at least one service server data.

The features, advantages, or similar expressions of the present invention are not to be construed as being limited by the single scope of the embodiment of the present invention. Please notice that the specific features, advantages, or characteristics described in the embodiments are included in at least one embodiment of this invention. Therefore, the description of features, advantages, and similar expressions therein current specification are related to the same specific embodiments but are not essential.

The following description, the attached claims or the description of the embodiments may be referred and therefore to realize the advantages of the present invention.

### BRIEF DESCRIPTION OF THE DRAWINGS

FIG. 1 is a schematic system architecture diagram of dynamic distribution service server of a preferable embodiment of the present invention.

FIG. 2 is a flow chart of dynamic distribution service server of a preferable embodiment of the present invention.

### DETAILED DESCRIPTION OF THE INVENTION

In order to make the description of the present disclosure more detailed and complete, the following description provides an illustrative description for the implementation and specific embodiments of the present invention. However, the following description is not the only form of implementing or using specific embodiments of the invention. In these paragraphs, the features of various specific embodiments are covered as well as the method steps and sequences for constructing and operating these specific embodiments. However, the other embodiments may also be utilized to achieve the same or equivalent function and sequence of steps.

The present invention discloses a method of distributing service server dynamically. The aforementioned method of distributing service server dynamically is performed in connections between an index server, a plurality of client devices, and a plurality of service servers. Hence, the method of the present invention decreases the load of the index server and helps the distributions of the services servers which belong to different organizations or provide different services. On the other hand, the present distribution method follows the rule defined by user or the system distribution rule defined by the system provider, and further distributes the service servers to the client devices of the user(s) accordingly.

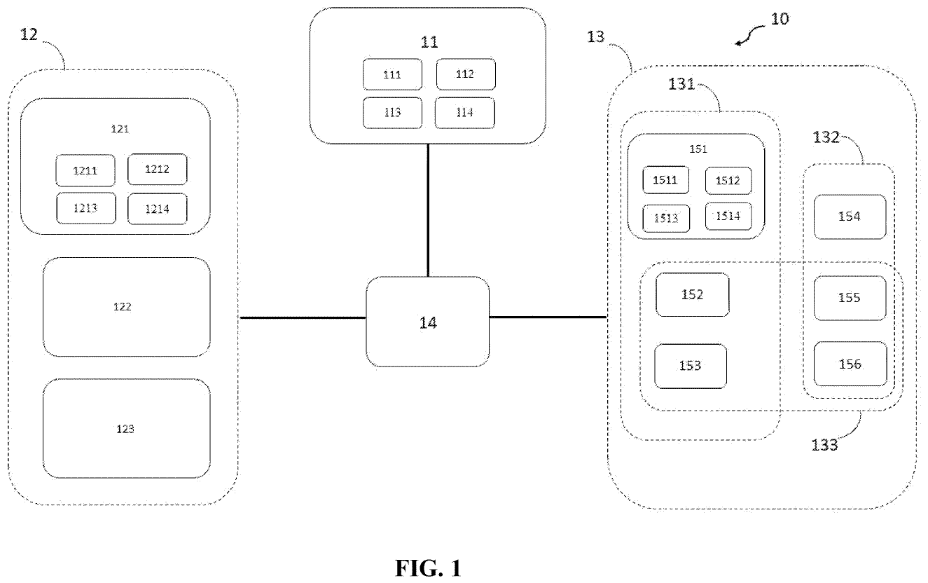

Please refer to FIG. 1, FIG. 1 is a schematic system architecture diagram of dynamic distribution service server of a preferable embodiment of the present invention. First of all, the use of the apparatuses and the function modules of this system are described as follows, and the operating step of the present system is illustrated thereafter. As shown in FIG. 1, the system 10 comprises an index server 11, a plurality of client devices 12 and a plurality of service servers 13. The index server 11, the plurality of client devices 12 and the plurality of service servers 13 are connected to each other based on an internet 14. The plurality of client devices 12 comprises a first client device 121, a second client device 122 and a third client device 123. The plurality of service servers 13 comprises service servers 151-156. In an embodiment of the present invention, the service server 151 and service server 152 are consisted in a first service server group 131. The service server 154, service server 155 and service server 156 are consisted in a second service server group 132. The service server 152, service server 153, service server 155 and service server 156 are consisted in a third service server group 133. Every service server may be assigned to the related group based on the attribution per se. For instance, the attribution mentioned may be server ID, IP address, port, service type, geographical location, load, computational capability and network speed thereof. Otherwise, the single service server is not limited to be consisted in one or more service server group, and each service server group is not limited to contain one or more service servers.

The index server 11 comprises a message module 111, storage module 112, authentication module 113 and configuration module 114. The message module 111 is able to be used for receiving the service server data of the service server 13 and the connection service request of client devices 12. On the other hand, the message module 111 may send client device connection notification to service server 13 or send service server group data or recommended service server data to client device 12. The service server data is provided by the service servers 151-156 of the plurality of service server 13. The different service server groups 131, 132 and 133 may provide different service server data for different groups. The service server data may comprise one or more combinations of server ID, IP address, port, service type, geographical location, load, computational capability and network speed, however the present invention is not limited thereto.

The connection service request is individually sent by the first client device 121, second client devices 122, third client device 123 of the plurality of client devices 12. The connection service request may comprise but not limited to identification number and service needs of the client device. The client device connection notification is used for the index server 11 to remind specific service server(s) that the certain client device(s) may request for establishing connection(s) therebetween. The purpose of the client device connection notification can preserve the computational capability of specific service server(s) and therefore to provide services for the connecting of client devices. The use of the present invention is not limited thereto. The index server 11 may receive recommended service server data based on system distribution rule. For instance, the first client device 121 needs specific service and sends connection service request to the index server 11. The index server 11 may receive the service server data of service server 151 as a recommended service server data based on the system distribution rule, and the index server 11 sends the recommended service server data (service server data of service server 151) and client device connection notification to the first client device 121 and service server 151 respectively. The client device connection notification mentioned herein comprises but not limited to the identification number of the client device. The abovementioned description indicates that the recommended service server data is determined by the system distribution rule when a connection service request of a client device is sent to the index server 11. The system distribution rule is that the index server 11 may determine the most suitable service server(s) for being the best connection option, and therefore the service server data of the chosen service server(s) is the recommended service server data mentioned above.

The storage module 112 is able to save service server data, system distribution rule and client device data, but the present invention is not limited thereto. The system distribution rule provides that the index server 11 may decide to send service server data of different groups to different client devices 121-123, or the index server 11 may decide the best connection option of at least one service server for certain client device. Hence, the index server 11 takes the service server data of the chosen service server as the recommended service server data. The filter condition of the system distribution rule comprises but not limited to the combinations of service type, geographical location, load, computational capability and network speed. The client device data is used for providing that the index server 11 may identify the attribution data of the plurality of client devices 12 and the plurality of client devices 12 are authorized or not. For example, the client device data may comprise identification number, geographical location or etc. of each client device, but the present invention is not limited thereto.

The authentication module 113 is used for verifying that the client device which sends the connection service request is authorized or not. For example, the authentication module 113 compares the client devices identification number of the connection service request with the client device data which is stored in the storage module 112. The authentication module 113 may execute calculations based on the system distribution rule stored in storage module 112, determining to send alternative or different service server group data to different client devices 121-123. The authentication module 113 may further select specific service server data as a recommended service server data according the system distribution rule, therefore to provide such recommended service server data to specific client devices. The authentication module 113 may determine whether to send the service server data of different groups to different client devices 121-123 when the service server data has been renewed. The configuration module 114 is used for providing a user interface and user(s) may edit the client device data or setting the filter condition(s) of system distribution rule.

The plurality of client devices 12 comprises a first client device 121, a second client device 122 and a third client device 123, however the present invention is not limited thereto. The client devices may be computer or smart phone, and each client device may install an application (APP) therefore to provide the configuration module. Every client device of each group comprises message module, storage module, authentication module and configuration module. To simplify the description, message module 1211, storage module 1212, authentication module 1213 and configuration module 1214 consisted in the first client device 121 will be used for the description hereinafter.

The message module 1211 is used for sending the connection service request to the index server 11, receiving the at least one service server group data or recommended service server data from the index server 11, establishing the connection between the at least one service servers which is corresponding to the service server group data, or establishing the connection between the service server which is corresponding to the recommended service server data. The storage module 1212 saves the service server data, the client distribution rule and the identification number of client devices. The client distribution rule provides the filter condition, therefore to make the client device decide establishing the connection between one of the service servers based on the received service server data or not. The authentication module 1213 may execute the client distribution rule stored in storage module 1212, determining whether to establish the connection between the one of the service servers of the service server data. The authentication module 1213 may alternatively determine whether to establish the connection between one of the service servers of the service server data when the service server data has been received again. The configuration module 1214 provides a user interface. The user may set the filter condition of the client distribution rule. Moreover, the user interface may display the service server data and the user is allowed to select one of the service servers of the shown service server data, therefore to establish the connection. The filter condition of the client distribution rule comprises but not limited to the combinations of service type, geographical location, load, computational capability or network speed.

The plurality of the service servers 13 comprise service servers 151-156. Specifically, the service servers 151-156 further divided into the first service server group 131, the second service server group 132, and the third service server group 133 thereon. Every service server comprises message module, storage module, authentication module and data generating module. For the clear description, the following description illustrates that the service server 151 comprises message module 1511, storage module 1512, authentication module 1513 and data generating module 1514.

The message module 1511 is used for sending service server data, receiving client device connection notification, and establishing connection between the client devices. The storage module 1512 saves the service server data, client device connection notification or the other data. The authentication module 1513 checks the client device connection notification between the client device which requests the connection is correct or not. The data generating module 1514 generates the service server data. The service server data may comprise the combinations of server ID, IP address, port, service type, geographical location, load, computational capability or network speed. Specifically, the time to trigger the data generating module 1514 to generate the service server data, comprising the certain period, certain time of a day or the renewal/changing of the service server.

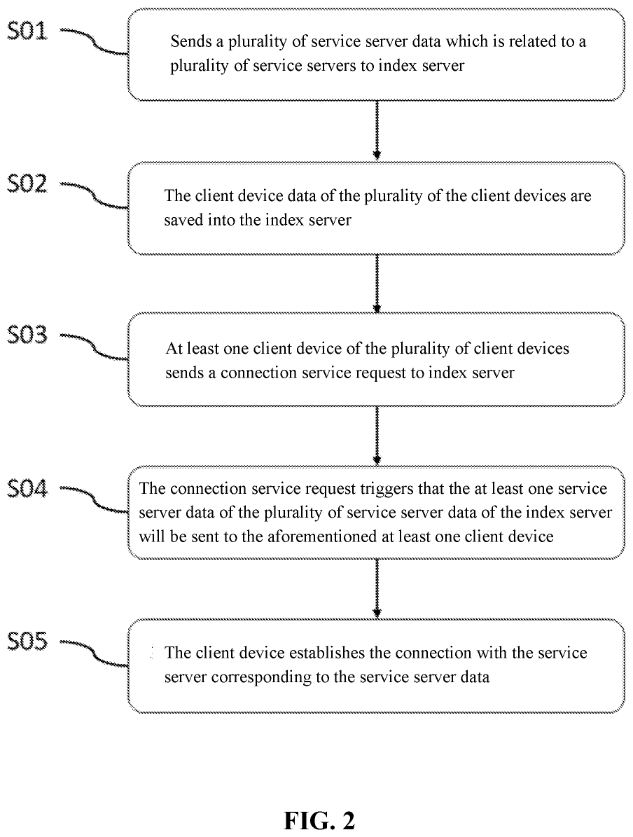

Please see FIG. 2. FIG. 2 illustrates a flow chart of dynamic distribution service server of a preferable embodiment of the present invention. Please further refer to FIG. 1 and FIG. 2 simultaneously as follows. First of all, the step S01 sends a plurality of service server data which is related to a plurality of service servers 13 to index server 11. For example, when the data generating module 1514 of the service server 151 generates the service server data, the message module 1511 of the service server 151 instantly sends the service server data to the index server 11 and saves the service server data in the storage module 112 of the index server 11. The foregoing description should be realized as the service servers 152-156 are allowed to send the service server data per se to the index server 11. On the other hand, the data generating modules of the service servers 151-156 are allowed to generate the renewed service server data thereinafter. The renewal time comprises but not limited to certain period, certain time of a day or the renewal/changing of the service server. If there is any service server has been renewed and generates a new service server data, the renewed service server data is allowed to be sent to the index server 11.

In step S02, the client device data of the plurality of the client devices 12 are saved into the index server 11. The user of index server 11 may set/select the filter condition of the system distribution rule or insert the client device data based on the user interface provided by configuration module 114. In an embodiment of the present invention, the inserted client device data may be identification number, geographical location or etc. of each client device. On the other hand, the filter condition of the system distribution rule may be set to select a service server which performs the best computational capability. The other capable filter conditions of the system distribution rule have been described above, the repeated description is omitted herein.

In step S03, at least one client device of the plurality of client devices 12 sends a connection service request to index server 11. For instance, when the first client device 1212 of the plurality of client devices 12 needs to establish a connection with a service server therefore to acquire a service, the message module 1211 of the first client device 121 will send a connection service request to index server 11. The connection service request comprises but not limited to identification number and service needs of the client device. The service needs contain the requirements for index server 11 to provide the service server data which matches the conditions of geographical location, greater computational capability or network speed, but the present invention is not limited thereto.

In step S04, the connection service request triggers that the at least one service server data of the plurality of service server data of the index server 11 will be sent to the aforementioned at least one client device. When the message module 111 of the index server 11 receives the connection service request which is sent from the first client device 121, the authentication module 113 of the index server 11 recognize first client device 121 is an authorized client device or not based on the sent connection service request. For instance, the identification number of the client device in the connection service request is used for checking the client device data saved in the storage module 112. The client device is only allowed to send the service server data to the first client device 121 after the client device has been checked and being authorized. In the present step, the authentication module 113 of the index server 11 may execute calculation based on the system distribution rule of storage module 112, determining to send service server data which is from different groups to the different client devices 121-123. Moreover, the specific service server data which is selected as a recommended service server data and sending to certain client device based on the system distribution rule is also allowed.

For example, the first client device 121 of paying user A (Client A) is located in Taipei City and the requirement of the computational capability is high; The second client device 122 of paying user B (Client B) is located in Taichung City and the requirement of computational capability is low; the third client device 123 of free user C (Client C) is located in Taipei City and the requirement of computational capability is low; The service servers 151 and 152 are the service servers which only allow to serve the paying user (Client) from Taipei City. The service servers 154, 155 and 156 are the service servers which only allow serving the paying user (Client) from Taichung City. The service servers 153 is a service server which serves the paying/free users (Clients) form Taipei City. In addition, the computational capability of service servers 152, 153, 155 and 156 are low or limited, and the computational capability of service servers 151 and 154 performs well. In the first distribution embodiment of the present invention, the system distribution rule regards the geographical location and payment status as the distribution criteria. The message module 111 of the index server 11 will send the service server data of the service servers 131 of the first group to the first client device 121 (the distribution between the paid server and the paying user (client) located in Taipei City). The message module 111 of the index server 11 will send the service server data of the service servers 132 of the second group to the second client device 122 (the distribution between the paid server and the paying user (client) located in Taichung City), and the message module 111 of the index server 11 will send the service server data of the service servers 153 to the third client device 123 (the distribution between the paid/free server and the free user (client) located in Taipei City).

In the second distribution embodiment of the present application, the distribution criteria of the system distribution rule are geographical location and computational capability. Therefore, the message module 111 of index server 11 sends the service server data of service servers 151 to the first client device 121 (the distribution between the server having high computational capability and the user (client) who requests for high computational capability in Taipei City). The message module 111 of index server 11 sends the service server data of service servers 155 and 156 to the second client device 122 (the distribution between the server having low computational capability and the user (client) who requests low computational capability in Taichung City), and the message module 111 of index server 11 sends the service server data of service servers 152 and 153 to the third client device 123 (the distribution between the server having low computational capability and the user (client) who requests low computational capability in Taipei City).

As the foregoing description, the system distribution rule may select the data with optimized condition of the data of certain service server as the recommended service server data and provide the recommended service server data to the specific client devices. For example, in the third distribution embodiment, the message module 111 of index server 11 sends the service server data of service servers 151 to the first client device 121 (the distribution between the paid server having high computational capability and the paying user (client) who requests high computational capability in Taipei City). The message module 111 of index server 11 sends the service server data of one chosen server from a group consisting of service servers 155 and 156 (the service server 155 is selected here) to the second client device 122 (the distribution between the paid server having low computational capability and the paying user (client) who requests low computational capability in Taichung City), and the message module 111 of index server 11 sends the service server data of service servers 153 to the third client device 123 (the distribution between the paid/free server having low computational capability and the free user (client) who requests low computational capability in Taipei City). When the message module 111 of index server 11 sends the recommended service server data, it also sends the client device connection notification notify the certain service server that the certain client device request for establishing connection. As the described third distribution embodiment, the message module 111 of index server 11 sends the client device connection notification which is used for notifying the service servers 151 that the first client device 121 will request for establishing connection. The message module 111 of index server 11 sends the client device connection notification which is used for notifying the service servers 155 that a client device 122 of the second group will request for establishing connection. The message module 111 of index server 11 sends the client device connection notification which is used for notifying the service servers 153 that the third client device 123 will request for establishing connection.

Furthermore, the step S04 further comprises that if the index server 11 receives the renewal of service server data, the authentication module 113 is allowed determining whether to send different service server data to different client devices 121-123 again. For example, the service servers 151-156 would renew the service server data per se because of the offline of server, the increased number of the connected client devices, network speed getting slower or the other reasons. Therefore, the content of the re-sent service server data is also changed.

In step S05, the client device establishes the connection with the service server corresponding to the service server data. In current step S05, the message module of every client device of the plurality of client devices 12 receives a service server group data or at least one service server data which is sent from the index server 11, and saves the service server group data or at least one service server data in the storage module. Therefore, the authentication module may execute the calculation based on the client distribution rule, which is saved in the storage module, therefore to determine establishing the connection with one of the service servers of the received service server data. When the plurality of the client devices 12 receives the re-sent service server data, the plurality of the client devices 12 may determine whether to establish a connection with one of the service servers of the re-sent service server data. In this step, the user of the client device can further use the user interface which is provided by the configuration module to set the filter conditions of client distribution rule. Moreover, the user interface may display the service server data received by the client device and the user is allowed to choose the at least one service servers from the service server data, and establishing the connection.

For instance, as the first distribution embodiment, the index server 11 sends the service server data of the first group of service servers 131 to the first client device 121. The index server 11 sends the service server data of the second group of service servers 132 to the second client device 122, and sends the service server data of the third group of service servers 153 to the third client device 123. That is, in the first connection embodiment, the user interface provided by configuration module 1214 of the first client device 121 displays the service server data which is received by the first client device 121 form the first group of the service servers 131. Thereafter, the user of the first client device 121 selects the one of the service servers of the first group of service servers 131 and establishes the connection. In a second connection embodiment, the authentication module 1213 of the first client device 121 may execute the calculation based on the client distribution rule of the storage module 1212, determining whether to establish the connection with the service server 151 (After the first client device 121 receives the service server data of the first group of service servers 131, the priority performed by the client distribution rule preferably select the service server which performs greater computational capability). Nevertheless, the user of each client device is still able to select the preferred service server and establishes the connection based on the user interface per se. The client distribution rule can also be defined by the user, then the connection between the service server would be automatically established based on the self-defined client distribution rule.

In the other embodiment of the present invention, the service server 151 located in Taipei City is a video service server which has the best computational capability. The service server 152 located in Taichung City is a video service server which has the best computational capability. The service server 154 is a video service server located in Taipei City. The service servers 155 is an audio service server located in Taipei City. The service server 156 is a text service server located in Taipei City. When the first client device 121 sends a connection service request to the index server 11, the index server 11 may follow the instant system distribution rule and divides the service servers 154, 155, 156 into second service server group 132. The service server data of the second service server group 132 will be provided to first client device 121 because the second service server group 132 comprises the servers which provide video, audio, and text services, which satisfy the most service needs. On the other hand, the second client device 122 sends a connection service request to the index server 11, and the index server 11 may follow the noted service needs of the connection service request (the user notes that the video service, a service server having the best computational capability, and the location of the user may be at Taipei or Taichung City). Thus, the index server 11 further follows the system distribution rule and divides the service servers 151, 152 into the first service server group 131. The service server data of the first service server group 131 will be sent to the second client device 122, directly satisfying the needs of the user of the second client device 122.

The above-mentioned description tells that the present invention proposes a dynamically distributing method for the service servers, which can reduce the load of the index server. The present invention distributes service servers of different providers or different organizations. The present invention can be operated and followed by system distribution rule of the system provider or the User-defined distribution rule and distributes service servers to user's client devices.

Various embodiments of the disclosed techniques have been described above. It should be understood that the embodiments have been presented by real case and are not limiting. Likewise, the actual architecture of the disclosed techniques in the various figures, or their configurations, may be depicted to aid in understanding the features and functionality that may be included in the disclosed technology. The disclosed technology is not limited to the illustrated embodiment architectures or configurations. Essential technical features in this embodiment may be implemented using a variety of alternatives or configurations. It will be apparent to the skilled person in the art, understanding the functional, logical, or physical partitioning and configurations may implement the desired features of the techniques disclosed herein. In addition, the flowcharts or operational descriptions and methods of the present invention, each step the order of presentation should not limit the technology disclosed herein. The order of steps in the implementation of the invention should not limit its functionality unless context dictates otherwise.

The above-mentioned descriptions are only preferred embodiments of the present invention and are not intended to limit the scope of implementation of the present invention. Therefore, all the shapes, structures, features and spirits described in the scope of the patent application of the present invention shall be regard as equivalent to the changes and modifications per se, and be included in the scope of the patent application of the present invention.

What is claimed is:

1. A method of distributing service server dynamically, operated between an index server, a plurality of client devices and a plurality of service servers; wherein the index server, the plurality of client devices and the plurality of service servers are connected based on an internet, and the dynamic distribution method comprises the following steps:
(A) sending a plurality of service server data which are corresponding to the plurality of service servers to the index server;
(B) saving a plurality of client device data of the plurality of client devices in the index server;
(C) at least one client device of the plurality of client devices sending a connection service request to the index server;
(D) sending at least one service server data of the plurality of service server data to the at least one client device for responding the connection service request; and
(E) establishing a connection between the at least one client device and a service server which is corresponding to the at least one service server data.

2. The method of distributing service server dynamically as claimed in claim 1, wherein the step (D) comprises: the index server following a system distribution rule and sending at least one service server group data of the plurality of service server data to the at least one client device.

3. The method of distributing service server dynamically as claimed in claim 2, wherein filter condition of the system distribution rule comprises: service type, service type, geographical location, load, computational capability, network speed or combinations thereof.

4. The method of distributing service server dynamically as claimed in claim 2, wherein the step (E) comprises: the at least one client device establishing the connection between the at least one client device and one of the service servers which is corresponding to the at least one service server group data based on a client distribution rule.

5. The method of distributing service server dynamically as claimed in claim 4, wherein the client distribution rule of the at least one client device is customized by user.

6. The method of distributing service server dynamically as claimed in claim 4, wherein each client device of the plurality of client devices is customized to follow different client distribution rule.

7. The method of distributing service server dynamically as claimed in claim 4, wherein filter condition of the client distribution rule comprises: service type, geographical location, load, computational capability, network speed or combinations thereof.

8. The method of distributing service server dynamically as claimed in claim 2, wherein the step (A) further comprises: sending renewal of the plurality of service server data to the index server, sending period of the renewal comprises: certain period, certain time of a day or change of one of the plurality of service servers.

9. The method of distributing service server dynamically as claimed in claim 8, wherein the step (D) further comprises: determining whether to send the at least one service server group data of the plurality of service server data to the at least one client device again for responding the renewal of the plurality of service server data.

10. The method of distributing service server dynamically as claimed in claim 9, wherein the step (E) further comprises: the at least one client device determining whether to re-establish the connection between the at least one client device and one of the service servers which is corresponding to the at least one service server group data for responding the at least one service server group data which is sent again.

11. The method of distributing service server dynamically as claimed in claim 1, wherein the step (D) comprises: the index server sending the at least one service server data as a recommended service server data to the at least one client device based on a system distribution rule.

12. The method of distributing service server dynamically as claimed in claim 11, wherein the step (D) comprises: sending a client device connection notification to the service server which is corresponding to the recommended service server data.

13. The method of distributing service server dynamically as claimed in claim 1, wherein the service server data comprises: server ID, IP address, port, service type, geographical location, load, computational capability, network speed or combinations thereof.

14. The method of distributing service server dynamically as claimed in claim 2, wherein the plurality of client devices is selected form a group of computer or smart phone, and an application (APP) is installed in the plurality of client devices.

15. The method of distributing service server dynamically as claimed in claim 14, wherein the application (APP) of the plurality of client devices provides a user interface (UI); wherein the user interface shows the at least one service server group data and provides user to select one of the service servers which is corresponding to the at least one service server group data, establishing the connection.
